(19) United States
(12) Patent Application Publication
(10) Pub. No.: US 2011/0069000 A1
(43) Pub. Date: Mar. 24, 2011

(54) SYSTEM FOR DISPLAYING IMAGES

(76) Inventor: Hsin-Yuan SU, Kaohsiung City (TW)

(21) Appl. No.: 12/888,868

(22) Filed: Sep. 23, 2010

(30) Foreign Application Priority Data
Sep. 24, 2009 (TW) 098132280

(51) Int. Cl. G09G 3/30

(52) U.S. Cl. 345/76

(57) ABSTRACT

A system for displaying images is provided. The system includes a full-color organic electroluminescent device having a bottom substrate. A reflection layer, a first transparent electrode, an organic electroluminescent unit, and a second transparent electrode are sequentially disposed on the bottom substrate. Particularly, a light enhancing layer is disposed between the bottom substrate and the first transparent electrode.

### CROSS REFERENCE TO RELATED APPLICATIONS

This application is based upon and claims the benefit of priority from the prior Taiwan Patent Application No. 098132280, filed on Sep. 24, 2009, the entire contents of which are incorporated herein by reference.

### BACKGROUND

1. Technical Field

The invention relates to a system for displaying images, and more particularly to a system for displaying images including a full-color organic electroluminescent device.

2. Description of the Related Art

Recently, with the development and wide application of electronic products such as mobile phones, personal digital assistants, and notebook computers, there has been an increased demand for flat display devices which consume less power and occupy less space. Organic electroluminescent devices are self-emitting and highly luminous, have a wide viewing angle, fast response time, and simple fabrication process, making them an industry display of choice.

In order to fabricate a top-emission organic electroluminescent device, U.S. Pat. No. 5,739,545 discloses an organic electroluminescent device with a transparent cathode, wherein the transparent cathode includes a low work-function metallic layer and a wide energy-gap layer formed on the low work-function metallic layer. The wide energy-gap layer, serving as a protection layer, prevents the organic electroluminescent layers and the low work-function metallic layer from being damaged during fabrication process of the top-emission organic electroluminescent device. However, because properties of the wide energy-gap layer, such as color purity and luminescence intensity, are poor, similar properties for the organic electroluminescent device of the invention made therefrom are also poor.

U.S. Pat. No. 6,984,934 discloses a method to prevent light between a class substrate and an anode from dissipating by forming a micro-lens array on the class substrate of the organic electroluminescent device. Although the method can increase extraction of light from the organic electroluminescent device, fabrication of the micro-lens array is complicated and difficult. Further, since the micro-lens array is formed outside of the glass substrate of the organic electroluminescent device, color purity of the organic electroluminescent device cannot be enhanced by the micro-lens array.

### BRIEF SUMMARY

An exemplary embodiment provides a system for displaying images. The system includes a full-color organic electroluminescent device including: a bottom substrate; a reflective layer disposed on the bottom substrate; a first transparent electrode; an organic electroluminescent element; and a second transparent electrode sequentially formed on the reflective layer. A light enhancing layer, disposed between the bottom substrate and the first transparent electrode.

In another exemplary embodiment, the top surface of the transparent connection layer, the top surface of the first transparent electrode, and/or the bottom surface of the protection layer comprise a plurality of protrusions.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a cross-section of a full-color organic electroluminescent device according to an embodiment of the invention.

FIG. 2 is a cross-section of a full-color organic electroluminescent device according to another embodiment of the invention.

FIG. 3 is a cross-section of a full-color organic electroluminescent device according to yet another embodiment of the invention.

FIG. 4 is a cross-section of the full-color organic electroluminescent device (1) as disclosed in Comparative Example 1.

FIG. 5 shows a graph plotting RGB luminescence intensity of the full-color organic electroluminescent device (1) as disclosed in Comparative Example 1.

FIG. 6 shows a graph plotting RGB luminescence intensity of the full-color organic electroluminescent device (2) as disclosed in Example 1.

FIG. 7 is a cross-section of the full-color organic electroluminescent device (3) as disclosed in Example 2.

FIG. 8 shows a graph plotting RGB luminescence intensity of the full-color organic electroluminescent device (3) as disclosed in Example 2.

FIG. 9 is a cross-section of the full-color organic electroluminescent device (4) as disclosed in Example 3.

FIG. 10 shows a graph plotting RGB luminescence intensity of the full-color organic electroluminescent device (4) as disclosed in Example 3.

FIG. 11 is a cross-section of the full-color organic electroluminescent device (5) as disclosed in Example 4.

FIG. 12 shows a graph plotting RGB luminescence intensity of the full-color organic electroluminescent device (5) as disclosed in Example 4.

FIG. 13 schematically shows a block diagram of a system for displaying images according to an embodiment of the invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

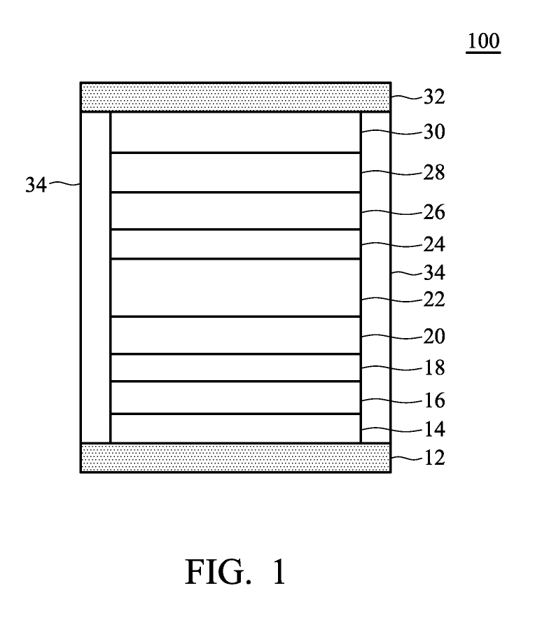

Referring to FIG. 1, a full-color organic electroluminescent device 100 employed by a system for displaying images according to an embodiment of the invention is provided. Herein, the full-color organic electroluminescent device 100 includes a bottom substrate 12, and a reflective layer 14, a transparent connection layer 16, a light enhancing layer 18, a first transparent electrode 20 (such as an anode), an organic electroluminescent element 22, and a second transparent electrode 24 (such as a cathode) subsequently formed on the bottom substrate 12. It should be noted that, since the organic electroluminescent device 100 has a specific sequence structure (reflective layer 14/transparent connection layer 16/light enhancing layer 18/first transparent electrode 20), the organic electroluminescent device 100 of the invention can exhibit increased luminescence intensity and improve RGB color purity.

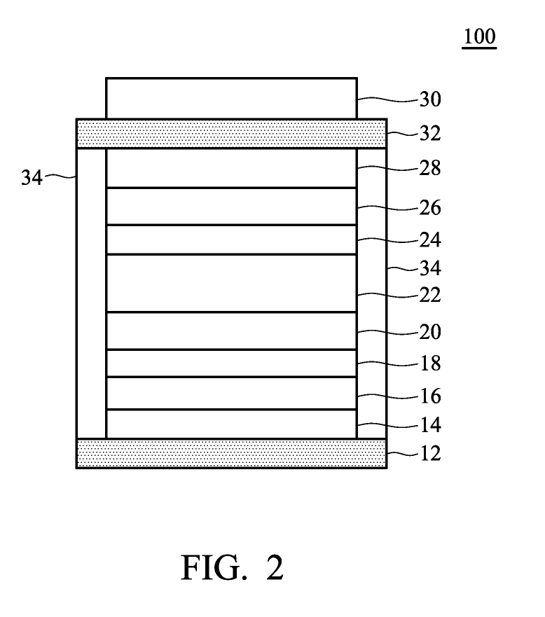

Further, the full-color organic electroluminescent device 100 can further include a top substrate (serving as a packaging substrate) 32, and a color filter film 30 and a protection layer (serving as a passivation layer) 28 subsequently formed on the bottom surface of the top substrate. Next, the top substrate 32 (with the protection layer 28 and the color filter film 30) is fixed on the second transparent electrode 24 via a buffer layer 26. Finally, an adhesive layer 34 is disposed between the top substrate 32 and the bottom substrate 12 to seal the full-color organic electroluminescent device 100, as shown in FIG. 1. According to another embodiment of the invention, the color filter film 30 can also be formed on the top substrate 32, as shown in FIG. 2.

The bottom substrate 12 can be a glass substrate, a plastic substrate, or a semiconductor substrate. The substrate 202 can be a substrate including a required element (such as a thin film transistor). The accompanying drawings illustrate the substrate 12 as a plain rectangle in order to simplify the illustration.

The reflective layer 14 can be a distributed Bragg reflector (DBR) reflecting scattered lights toward the bottom substrate 12 for total reflection. The reflective layer 14 can include Ag, Al, Au, or combinations thereof. The transparent connection layer 16 exhibits high transmittance and can include indium tin oxide (ITO), indium zinc oxide (IZO), aluminum zinc oxide (AZO), zinc oxide (ZnO), or combinations thereof. The light enhancing layer 18 includes a material with high refractive index. For example, the refractive index of the light enhancing layer 18 is more than the refractive index of the transparent connection layer 16 or the refractive index of the first transparent electrode 20. The light enhancing layer 18 can include materials with a refractive index of more than 2.1, such as ZnSe (refractive index 2.6), or ZnS (refractive index 2.4).

The first transparent electrode 20 serving as an anode can include transparent metal or metallic oxide, such as tin oxide (ITO), indium zinc oxide (IZO), aluminum zinc oxide (AZO), or zinc oxide (ZnO). The method for forming the above layers (the reflective layer 14, the transparent connection layer 16, the light enhancing layer 18, and the first transparent electrode 20) is unlimited and can be a sputtering, electron beam evaporation, thermal evaporation, or chemical vapor deposition process.

The organic electroluminescent element 22 can at least include a light emitting layer, and can further include a hole injection layer, a hole transport layer, an electron transport layer, and/or an electron injection layer. The layers of the organic electroluminescent element 22 can include small molecule organic electroluminescent materials or polymer organic electroluminescent materials.

The layer of small molecule organic electroluminescent materials can be formed by a thermal vacuum evaporation process, and the layer of polymer organic electroluminescent materials can be formed by a spin coating, ink-jet printing, or screen printing process.

Each emitting layer of the organic electroluminescent element 22 can include one or multiple light-emitting materials and electroluminescent dopants doped into the light-emitting materials and can perform energy transfer or carrier trapping under electron-hole recombination in the emitting layer. The light-emitting material can be fluorescent or phosphorescent. The layers, materials, dopant dose, and the thickness of the organic electroluminescent element 22 are not limited and can be optionally modified by a person of ordinary skill in the field. Suitable materials of the second transparent electrode 24 serving as a cathode can include transparent metal or metallic oxide, such as tin oxide (ITO), indium zinc oxide (IZO), aluminum zinc oxide (AZO), or zinc oxide (ZnO). The method for forming the second transparent electrode 24 is unlimited and can be a sputtering, electron beam evaporation, thermal evaporation, or chemical vapor deposition process. The buffer layer 26 can be formed on the second transparent electrode 24 to combine the top substrate 32 and the bottom substrate 12. Since the buffer layer 26 and the protection layer 28 can be dovetailed into each other, there is no residual moisture and air in the full-color organic electroluminescent device 100. After combining the buffer layer 26 and the protection layer 28, the adhesive layer 34 is subjected to a curing process. Suitable materials of the buffer layer can be visible-light-induced photocurable material or an ultraviolet-light-induced photocurable material, such as photocurable resin. The method for forming the buffer layer can be a spin coating, ink-jet printing, or screen printing process. Since the protection layer (passivation layer) 28 can prevent oxygen and moisture in the ambient environment from entering into the full-color organic electroluminescent device, the electrodes and the organic layers can be prevented from being damaged and the operating lifespan of the full-color organic electroluminescent device can be extended.

Suitable materials of the protection layer can be silicon oxide, aluminium oxide, silicon nitride, silicon oxynitride, or combinations thereof. The materials of the color filter film are unlimited and can include a green color filter, red color filter, blue color filter, white color filter, or permutations and combinations thereof for achieving full-color display. The material of the packaging substrate 32 is unlimited and the packaging substrate 32 can be a transparent substrate, such as a glass substrate, or a plastic substrate.

According to an embodiment of the invention, the process for forming the full-color organic electroluminescent device 100 can be divided into a process for forming the first part and a process for forming a second part. The process for forming the first part includes subsequently forming the reflective layer 14, the transparent connection layer 16, the light enhancing layer 18, the first transparent electrode 20, the organic electroluminescent element 22, the first transparent electrode 24, and the buffer layer 26 on the bottom substrate 12. Meanwhile, the process for forming the second part includes subsequently forming the color filter film 30 and the protection layer 28 on the top substrate 32. Next, the first part and the second part are combined, forcing the buffer layer 26 and the protection layer 28 to be dovetailed into each other. After, the buffer layer 26 is subjected to a curing process (such as UV curing). Finally, the top substrate and the bottom substrate are enveloped by an adhesive layer 34.

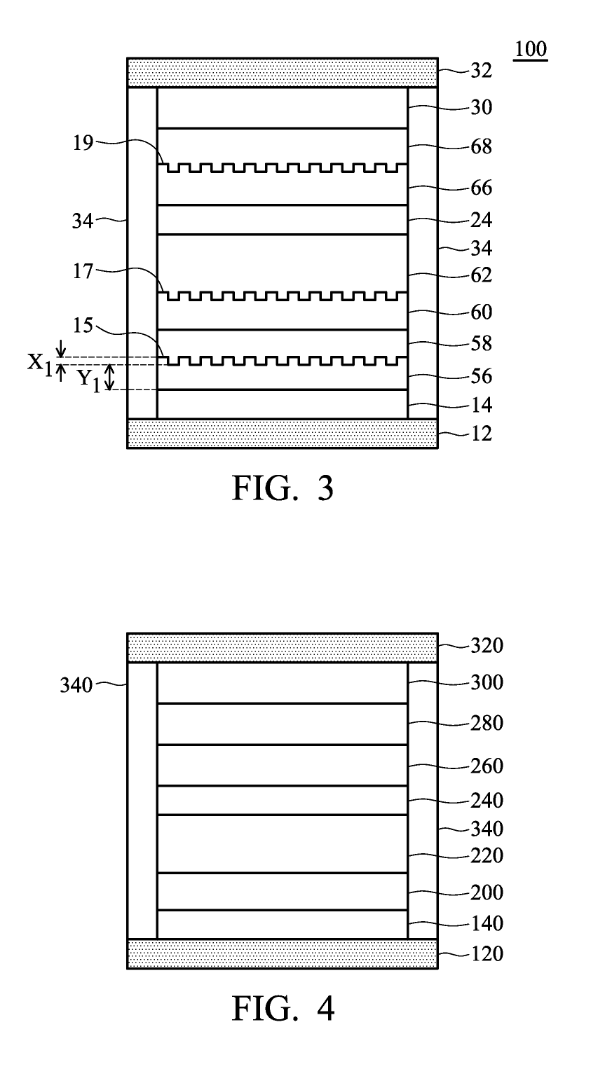

According to another embodiment of the invention, at least one of the top surface 15 of the transparent connection layer 56, the top surface 17 of the first transparent electrode 60 and the bottom surface 19 of the protection layer 68 can have a plurality of protrusions disposed thereon, as shown in FIG. 3. As a result, the transparent connection layer 56, the light enhancing layer 58, the first transparent electrode 60, and/or the protection layer 68 may have an alternate thickness at the interface thereof contacting to the top surface 15, the top surface 17, and/or the bottom surface 19. Therefore, lights emitted by the organic electroluminescent device 100 are apt to emit to the outside of the device (i.e. the light extraction efficiency of the organic electroluminescent device 100 is increased). Meanwhile, the RGB luminescence intensity and the color purity of the organic electroluminescent device 100 are simultaneously improved. The shapes of the protrusion are unlimited and can be circular, elliptical, polygonal or combinations thereof. The method for forming the protrusions (or depressions) can be a photolithography process or phase shift mask process having a halftone mask.

In an embodiment of the invention, the ratio between the height X of the protrusion and the thickness Y of the layer can be from 1:1 to 1:3. For example, the height X of the protrusion can be 70 nm and the thickness Y of the layer can be 130 nm.

The following examples are intended to illustrate the invention more fully without limiting their scope, since numerous modifications and variations will be apparent to those skilled in this art.

### Comparative Example 1

A glass substrate 120 was provided and then washed by a cleaning agent, acetone, and isopropanol with ultrasonic agitation. After drying at 120□, the glass substrate 120 was subjected to a uv/ozone treatment. Next, as shown in FIG. 4, a reflective layer 140, a first transparent electrode 200, an organic electroluminescent element 220, a second transparent electrode 240, a buffer layer 260, a protection layer 280, a color filter film 300 and a packaging substrate 320 were subsequently disposed on the glass substrate 120. Finally, the adhesive layer 340 was disposed between the packaging substrate 320 and the glass substrate 120 to bond the packaging substrate 320 with the glass substrate 120, obtaining the organic electroluminescent device (1). For purposes of clarity, the materials of the above layers are described in the following.

The reflective layer 140, with a thickness of 150 nm, comprised Al. The first transparent electrode 200, with a thickness of 30 nm, comprised ITO (Indium tin oxide). The organic electroluminescent element 220, formed from a bottom side to a top side, included: a hole injection layer with a thickness of 5 nm comprising 4,4′,4″-tris[N,(3-methylphenyl)-N-phenyl-amino]riphenylamine (m-TDATA); a hole transport layer with a thickness of 10 nm comprising 4,4′-bis[N-(1-naphthyl)-N-phenylamino]biphenyl (α-NPD); a first emitting layer (emitting red light) with a thickness of 40 nm comprising 8-hydroxyquinoline aluminum (Alq₃) as a host, and a red dopant (with a trade No. RD3, sold and manufactured by Kodak), wherein the weight ratio between Alq₃ and RD3 was 100:1; a second emitting layer (emitting green light) with a thickness of 40 nm comprising 8-hydroxyquinoline aluminum (Alq₃) and C545T (10-(2-Benzothiazolyl)-2,3,6,7-tetrahydro-1,1,7,7-tetramethyl-1H,5H,11H-(1)benzopyropyrano(6, 7-8-l,j)quinolizin-11-one) as a dopant, wherein the weight ratio between Alq₃ and C545T was 10:1; a third emitting layer (emitting blue light) with a thickness of 40 nm comprising 9,10-bis(2-naphthyl)anthracene (AND) as a host and bis[4-(di-p-tolylamino)styryl]biphenyl (DPAVBi) as a dopant, wherein the weight ratio between Alq₃ and C545T was 100:7.5; an electron transport layer with a thickness of 40 nm comprising bis(10-hydroxybenzo[h]quinolinato)beryllium (BeBq₂); and an electron injection layer with a thickness of 1 nm, comprising LiF. The second transparent electrode 240, with a thickness of 80 nm, comprised IZO (indium zinc oxide). The buffer layer 260, with a thickness of 6 μm, comprised acrylic resin. The protection layer 280, with a thickness of 400 nm, comprised silicon nitride (SiNx). The color filter film 300 had a thickness of 1 μm.

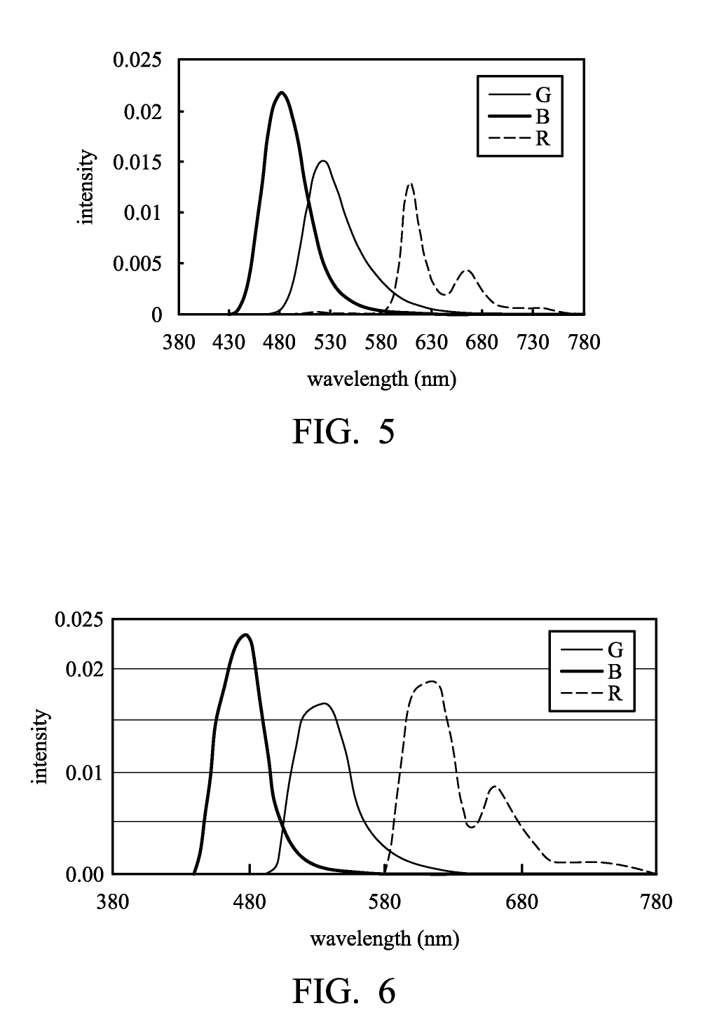

The optical properties of the electroluminescent device (1), as described in the Comparative Example 1, were measured by a PR650 (purchased from Photo Research Inc.) and Minolta LS110. Referring to FIG. 5, the RGB luminescence intensity of the electroluminescent device (1) were 0.013, 0.015, and 0.022 respectively.

### Example 1

A glass substrate 12 was provided and then washed by a cleaning agent, acetone, and isopropanol with ultrasonic agitation. After drying at 120□, the glass substrate 12 was subjected to a uv/ozone treatment. Next, as shown in FIG. 1, a reflective layer 14, transparent connection layer 16, light enhancing layer 18, first transparent electrode 20, organic electroluminescent element 22, second transparent electrode 24, buffer layer 26, protection layer 28, color filter film 30, and a packaging substrate 32 were subsequently disposed on the glass substrate 12. Finally, the adhesive layer 34 was disposed between the packaging substrate 32 and the glass substrate 12 to bond the packaging substrate 32 with the glass substrate 12, obtaining the organic electroluminescent device (2). For purposes of clarity, the materials of the above layers are described in the following.

The reflective layer 14, with a thickness of 150 nm, comprised Al. The transparent connection layer 16, with a thickness of 30 nm, comprised ITO (Indium tin oxide). The light enhancing layer 18, with a thickness of 5 nm, comprised zinc selenide (ZnSe). The first transparent electrode 20, with a thickness of 30 nm, comprised ITO (Indium tin oxide). The organic electroluminescent element 22 had the same layers and sequence of layers as the organic electroluminescent element 220 disclosed in Comparative Example 1. The second transparent electrode 24, with a thickness of 80 nm, comprised IZO (indium zinc oxide). The buffer layer 26, with a thickness of 6 μm, comprised acrylic resin. The protection layer 28, with a thickness of 400 nm, comprised silicon nitride (SiNx).

The optical properties of the electroluminescent device (2), as described in Example 1, were measured by a PR650 (purchased from Photo Research Inc.) and Minolta LS110. Referring to FIG. 6, the RGB luminescence intensity of the electroluminescent device (2) were 0.018, 0.016, and 0.023 respectively.

Due to the structure (reflective layer/transparent connection layer/light enhancing layer/first transparent electrode) of the electroluminescent device (2), the electroluminescent device (2) showed increased RGB luminescence intensity in comparison with the electroluminescent device (1).

### Example 2

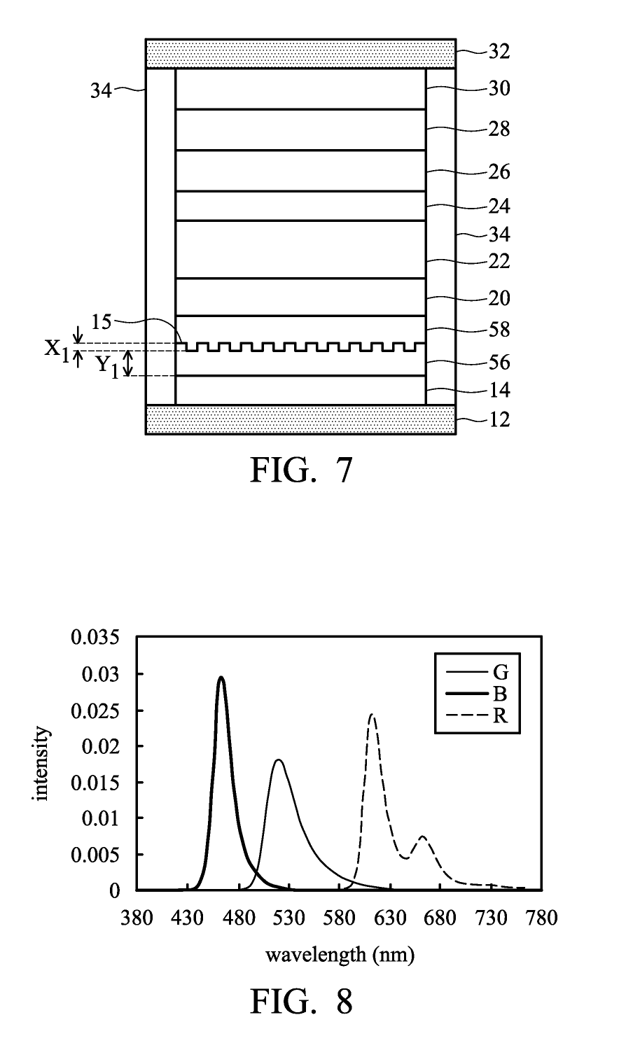

A glass substrate 12 was provided and then washed by a cleaning agent, acetone, and isopropanol with ultrasonic agitation. After drying at 120□, the glass substrate 12 was subjected to a uv/ozone treatment. Next, as shown in FIG. 7, a reflective layer 14, transparent connection layer 56, light enhancing layer 58, first transparent electrode 20, organic electroluminescent element 22, second transparent electrode 24, buffer layer 26, protection layer 28, color filter film 30, and a packaging substrate 32 were subsequently disposed on the glass substrate 12. Particularly, the transparent connection layer 56 had a plurality of protrusions disposed on the top surface 15 of the transparent connection layer, wherein the height X₁ of the protrusions was 70 nm, and the thickness Y₁ of the transparent connection layer 56 was 130 nm. Finally, the adhesive layer 34 was disposed between the packaging substrate 32 and the glass substrate 12 to bond the packaging substrate 32 with the glass substrate 12, obtaining the organic electroluminescent device (3). For purposes of clarity, the materials of the above layers are described in the following.

The reflective layer 14, with a thickness of 150 nm, comprised Al. The transparent connection layer 56 comprised ITO (Indium tin oxide), wherein the thickness Y₁ of the transparent connection layer 56 was 130 nm, and the height X₁ of the protrusions was 70 nm. The light enhancing layer 58, with a thickness of 5 nm, comprised zinc selenide (ZnSe). The first transparent electrode 20, with a thickness of 30 nm, comprised ITO (Indium tin oxide). The organic electroluminescent element 22 had the same layers and sequence of layers as the organic electroluminescent element 220 disclosed in Comparative Example 1. The second transparent electrode 24, with a thickness of 80 nm, comprised IZO (indium zinc oxide). The buffer layer 26, with a thickness of 6 μm, comprised acrylic resin. The protection layer 28, with a thickness of 400 nm, comprised silicon nitride (SiNx).

The optical properties of the electroluminescent device (3), as described in Example 2, were measured by a PR650 (purchased from Photo Research Inc.) and Minolta LS110. Referring to FIG. 8, the RGB luminescence intensity of the electroluminescent device (3) were 0.0242, 0.018, and 0.0293 respectively.

Due to the structure (reflective layer 14/transparent connection layer 56/light enhancing layer 58/first transparent electrode 20) and the plurality of protrusions of the transparent connection layer 56 of the electroluminescent device (3), the electroluminescent device (3) showed increased RGB luminescence intensity in comparison with the electroluminescent device (1).

### Example 3

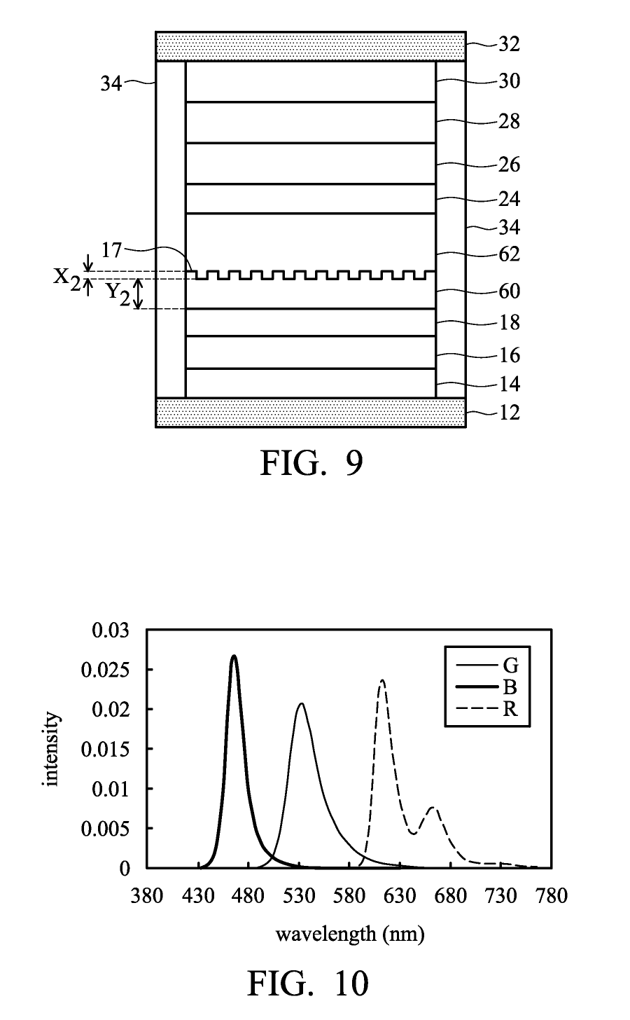

A glass substrate 12 was provided and then washed by a cleaning agent, acetone, and isopropanol with ultrasonic agitation. After drying at 120□, the glass substrate 12 was subjected to a uv/ozone treatment. Next, as shown in FIG. 9, a reflective layer 14, transparent connection layer 16, light enhancing layer 18, first transparent electrode 60, organic electroluminescent element 62, second transparent electrode 24, buffer layer 26, protection layer 28, color filter film 30, and a packaging substrate 32 were subsequently disposed on the glass substrate 12. Particularly, the first transparent electrode 60 had a plurality of protrusions disposed on the top surface 17 of the first transparent electrode 60, wherein the height X₂ of the protrusions was 70 nm, and the thickness Y₂ of the first transparent electrode 60 was 130 nm. Finally, the adhesive layer 34 was disposed between the packaging substrate 32 and the glass substrate 12 to bond the packaging substrate 32 with the glass substrate 12, obtaining the organic electroluminescent device (4). For purposes of clarity, the materials of the above layers are described in the following.

The reflective layer 14, with a thickness of 150 nm, comprised Al. The transparent connection layer 16 with a thickness of 30 nm, comprised ITO (Indium tin oxide). The light enhancing layer 18, with a thickness of 5 nm, comprised zinc selenide (ZnSe). The first transparent electrode 60 comprised ITO (Indium tin oxide), wherein the thickness Y₂ of the first transparent electrode 60 was 130 nm, and the height X₂ of the protrusions was 70 nm. The organic electroluminescent element 22 had the same layers and sequence of layers as the organic electroluminescent element 220 disclosed in Comparative Example 1. The second transparent electrode 24, with a thickness of 80 nm, comprised IZO (indium zinc oxide). The buffer layer 26, with a thickness of 6 μm, comprised acrylic resin. The protection layer 28, with a thickness of 400 μm, comprised silicon nitride (SiNx).

The optical properties of the electroluminescent device (4), as described in Example 3, were measured by a PR650 (purchased from Photo Research Inc.) and Minolta LS110. Referring to FIG. 10, the RGB luminescence intensity of the electroluminescent device (4) were 0.0234, 0.021, and 0.0265 respectively.

Due to the structure (reflective layer 14/transparent connection layer 16/light enhancing layer 18/first transparent electrode 60) and the plurality of protrusions of the first transparent electrode 60 of the electroluminescent device (4), the electroluminescent device (4) showed increased RGB luminescence intensity in comparison with the electroluminescent device (1).

### Example 4

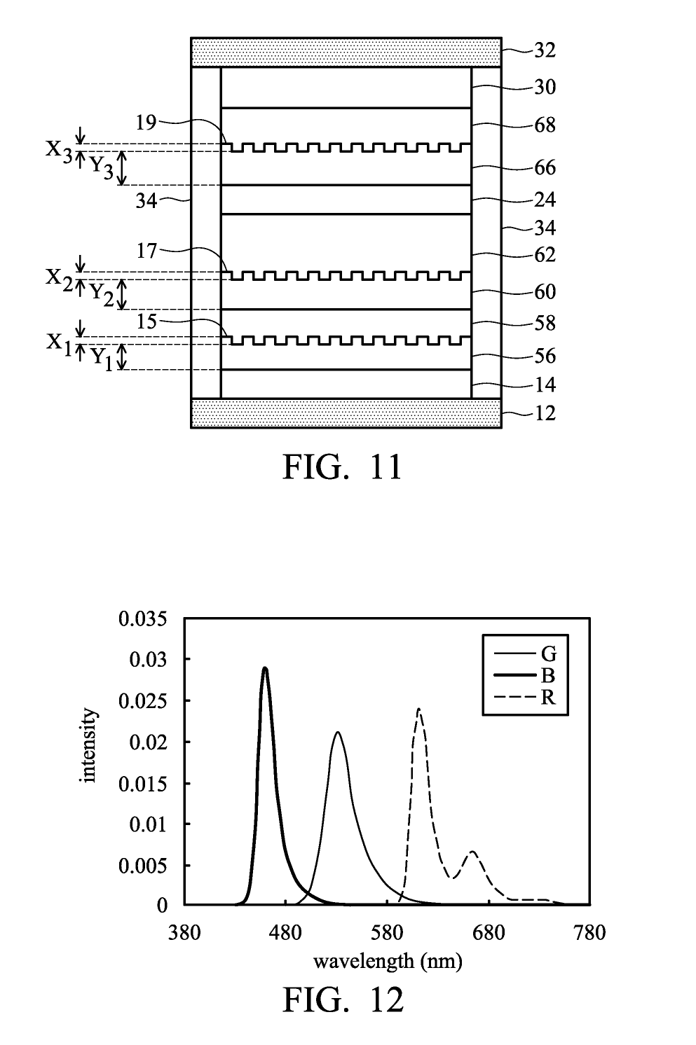

A glass substrate 12 was provided and then washed by a cleaning agent, acetone, and isopropanol with ultrasonic agitation. After drying at 120□, the glass substrate 12 was subjected to a uv/ozone treatment. Next, as shown in FIG. 11, a reflective layer 14, transparent connection layer 56, light enhancing layer 58, first transparent electrode 60, organic electroluminescent element 62, second transparent electrode 24, buffer layer 66, protection layer 68, color filter film 30, and a packaging substrate 32 were subsequently disposed on the glass substrate 12.

Particularly, the transparent connection layer 56 has a plurality of protrusions disposed on the top surface 15 of the transparent connection layer 56, the first transparent electrode 60 has a plurality of protrusions disposed on the top surface 17 of the first transparent electrode 60, and the protection layer 68 has a plurality of protrusions disposed on the bottom surface 19 of the protection layer 68. Finally, the adhesive layer 34 was disposed between the packaging substrate 32 and the glass substrate 12 to bond the packaging substrate 32 with the glass substrate 12, obtaining the organic electroluminescent device (5). For purposes of clarity, the materials of the above layers are described in the following.

The reflective layer 14, with a thickness of 150 nm, comprised Al. The transparent connection layer 56 comprised ITO (Indium tin oxide), wherein the thickness Y₁ of the transparent connection layer 56 was 130 nm, and the height X₁ of the protrusions was 70 nm. The light enhancing layer 58, with a thickness of 5 nm, comprised zinc selenide (ZnSe). The first transparent electrode 60 comprised ITO (Indium tin oxide), wherein the thickness Y₂ of the first transparent electrode 60 was 130 nm, and the height X₂ of the protrusions was 70 nm. The organic electroluminescent element 62 had the same layers and sequence of layers as the organic electroluminescent element 220 disclosed in Comparative Example 1. The second transparent electrode 24, with a thickness of 80 nm, comprised IZO (indium zinc oxide). The buffer layer 66, with a thickness of 6 μm, comprised acrylic resin. The protection layer 68 comprised silicon nitride (SiNx), wherein the thickness Y₃ of the protection layer 68 was 100 nm, and the height X₃ of the protrusions was 70 nm.

The optical properties of the electroluminescent device (5), as described in Example 4, were measured by a PR650 (purchased from Photo Research Inc.) and Minolta LS110. Referring to FIG. 12, the RGB luminescence intensity of the electroluminescent device (5) were 0.024, 0.021, and 0.029 respectively.

Due to the structure (reflective layer 14/transparent connection layer 56/light enhancing layer 58/first transparent electrode 60) and the plurality of protrusions of the transparent connection layer, the first transparent electrode, and the protection layer of the electroluminescent device (5), the electroluminescent device (5) showed increased RGB luminescence intensity in comparison with the electroluminescent device (1). Further, since the electroluminescent device (5) had narrower FWHM (full width at half maximum) for RGB lights in comparison with the electroluminescent device (1), the electroluminescent device (5) of the invention had improved color purity, as shown in FIG. 12.

In comparison with Comparative Example 1, luminescence intensity of the full-color organic electroluminescent devices as disclosed in the Examples were higher due to the reflective layer/transparent connection layer/light enhancing layer/first transparent electrode structure of the Examples. Further, since the transparent connection layer, the first transparent electrode, and/or the protection layer can include a plurality of protrusions on a surface thereof, RGB luminescence intensity and RGB color purity of full-color organic electroluminescent devices utilizing the structure can be simultaneously improved.

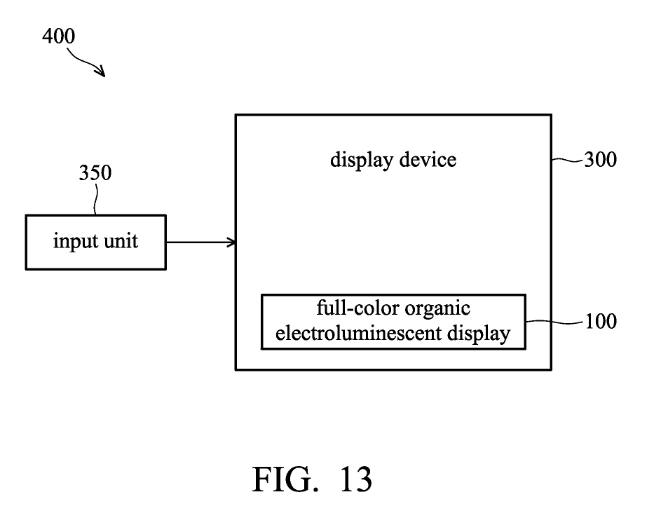

FIG. 13 schematically shows another embodiment of a system for displaying images which, in this case, is implemented as a display device 300 or an electronic device 400, such as a notebook computer, mobile phone, digital camera, PDA (personal data assistant), desktop computer, television, car display, or portable DVD player. The display device 300 (such as a full-color display device) includes the full-color organic electroluminescent device 100. In some embodiments, the display panel 300 can form a portion of a variety of electronic devices (in this case, electronic device 400). As shown in FIG. 13, the electronic device 400 can include the display device 300 and an input unit 350. Further, the input unit 350 can be operatively coupled to the display panel 300 and provide input signals (e.g., an image signal) to the display panel 400 to generate images.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for displaying images, comprising:
a full-color organic electroluminescent device, comprising:
a bottom substrate;
a reflective layer disposed on the bottom substrate;
a first transparent electrode, an organic electroluminescent element, and a second transparent electrode sequentially formed on the reflective layer; and
a light enhancing layer, disposed between the bottom substrate and the first transparent electrode.

2. The system as claimed in claim 1, wherein the reflective layer comprises Ag, Al, Au, or combinations thereof.

3. The system as claimed in claim 1, wherein a refractive index of the light enhancing layer is less than a refractive index of the first transparent electrode.

4. The system as claimed in claim 1, wherein the light enhancing layer has a refractive index more than 2.1.

5. The system as claimed in claim 1, wherein the light enhancing layer comprises ZnSe, or ZnS.

6. The system as claimed in claim 1, wherein the full-color organic electroluminescent device further comprises a transparent connection layer disposed between the light enhancing layer and the reflective layer.

7. The system as claimed in claim 6, wherein the transparent connection layer comprises ITO, IZO, AZO, ZnO, or combinations thereof.

8. The system as claimed in claim 6, wherein a refractive index of the light enhancing layer is more than a refractive index of the transparent connection layer.

9. The system as claimed in claim 6, wherein the transparent connection layer has a plurality of protrusions disposed on a top surface of the transparent connection layer, and the ratio between the height of the protrusion and the thickness of the transparent connection layer is from 1:1 to 1:3.

10. The system as claimed in claim 1, wherein the first transparent electrode has a plurality of protrusions disposed on a top surface of the first transparent electrode, and the ratio between the height of the protrusion and the thickness of the first transparent electrode is from 1:1 to 1:3.

11. The system as claimed in claim 1, wherein the full-color organic electroluminescent device further comprises a buffer layer formed on the second transparent electrode.

12. The system as claimed in claim 11, wherein the buffer layer comprises a visible-light-induced photocurable material or an ultraviolet-light-induced photocurable material.

13. The system as claimed in claim 11, wherein the full-color organic electroluminescent device further comprises:
a protection layer disposed on the buffer layer; and
a top substrate disposed on the protection layer.

14. The system as claimed in claim 13, wherein the protection layer has a plurality of protrusions disposed on a bottom surface of the protection layer, and the ratio between the height of the protrusion and the thickness of the protection layer is from 1:1 to 1:3.

15. The system as claimed in claim 13, wherein the full-color organic electroluminescent device further comprises a color filter film disposed between the protection layer and the top substrate or disposed on the top substrate.

16. The system as claimed in claim 13, wherein the protection layer comprises silicon oxide, titanium oxide, aluminium oxide, silicon nitride, or silicon oxynitride.

17. The system as claimed in claim 1, further comprising a display device comprising the full-color organic electroluminescent device.

18. The system as claimed in claim 17, further comprising:
an electronic device, wherein the electronic device comprises the display device, and an input unit coupled to the display device to provide input to the display device such that the display device displays images.

19. The system as claimed in claim 18, wherein the electronic device is a mobile phone, digital camera, personal digital assistant, notebook computer, desktop computer, television, car display, or portable DVD player.
